(19) United States
(12) Patent Application Publication
(10) Pub. No.: US 2026/0126933 A1
(43) Pub. Date: May 7, 2026

(54) STORAGE DEVICE AND METHOD FOR PROGRAM

(71) Applicant: Samsung Electronics Co., Ltd., Suwon-si (KR)

(72) Inventors: Jangryul Kim, Suwon-si (KR); Jinyong Park, Suwon-si (KR); Jeongjae Cho, Suwon-si (KR); In-su Kim, Suwon-si (KR)

(21) Appl. No.: 19/363,933

(22) Filed: Oct. 21, 2025

(30) Foreign Application Priority Data
Nov. 6, 2024 (KR) 10-2024-0156184

(51) Int. Cl. G06F 3/06; G06F 11/14

(52) U.S. Cl. CPC G06F 3/0655; G06F 3/0604; G06F 3/0679; G06F 11/1448; G06F 2201/805

(57) ABSTRACT

A storage device may include a plurality of non-volatile memories and a storage controller electrically connected to the plurality of non-volatile memories through a plurality of channels and a plurality of ways. The plurality of ways may be included in way groups. The storage controller may be configured to pre-program input data into the plurality of non-volatile memories through the plurality of ways, and re-program the input data into the plurality of non-volatile memories through different one of the way groups during time periods that do not overlap with each other, after the pre-program is completed.

### CROSS-REFERENCE TO RELATED APPLICATIONS

This U.S. non-provisional application claims priority under 35 U.S.C. § 119 to Korean Patent Application No. 10-2024-0156184, filed on Nov. 6, 2024, in the Korean Intellectual Property Office, the disclosure of which is herein incorporated by reference in its entirety.

### BACKGROUND OF THE INVENTION

Example embodiments relate to a storage device and a method for program.

A storage device may store data under the control of a host device such as a computer, a smartphone, or a tablet. Most storage devices are powered by an external power supply. However, storage devices are susceptible to damage, including data loss, due to failures of the external power supply or power-off such as sudden power-off (SPO).

To address the above power-related issue, an auxiliary power device may be included within the storage device to support data backup (or dump). However, the power supply for data backup may depend on the capacity of the auxiliary power device. Accordingly, it may be beneficial to reduce the dependency on the capacity of the auxiliary power device and improve data reliability by decreasing the amount of data backed up during a power-off situation.

### SUMMARY OF THE INVENTION

Example embodiments provide a storage device, capable of reducing the backup amount of data during a sudden power-off (SPO) event, and a method for program.

According to some example embodiments, a storage device may include a plurality of non-volatile memories and a storage controller electrically connected to the plurality of non-volatile memories through a plurality of channels and a plurality of ways. The plurality of ways may be included in way groups. The storage controller may be configured to pre-program input data into the plurality of non-volatile memories through the plurality of ways, and re-program the input data into the plurality of non-volatile memories through different ones of the way groups during time periods that do not overlap with each other, after the pre-program is completed.

According to some example embodiments, a method of operating a storage device may include pre-programming input data into a plurality of non-volatile memories through a plurality of channels and a plurality of ways, where the plurality of ways are included in way groups, and re-programming the input data into the plurality of non-volatile memories through different ones of the way groups during time periods that do not overlap with each other, after the pre-programming is completed.

According to some example embodiments, a storage device may include a plurality of non-volatile memories and a storage controller electrically connected to the plurality of non-volatile memories through a plurality of channels and a plurality of ways. The storage controller may be configured to pre-program input data into the plurality of non-volatile memories through the plurality of ways, and re-program the input data into at least one of the plurality of non-volatile memories through ones of the plurality of ways, a number of which is less than a predetermined threshold value, during a time period.

### BRIEF DESCRIPTION OF DRAWINGS

FIG. 1 is a block diagram of a storage device according to example embodiments.

FIG. 2 is a block diagram illustrating an example of the storage controller of FIG. 1 according to example embodiments.

FIG. 3 is a block diagram illustrating an example of a non-volatile memory of FIG. 1 according to example embodiments.

FIG. 4 is a circuit diagram illustrating an example of a memory block within a memory cell array of FIG. 1 according to example embodiments.

FIG. 5 is a diagram illustrating data states based on a pre-program operation and a re-program operation according to example embodiments.

FIGS. 6 and 7 are timing diagrams illustrating backup operations during a sudden power-power (SPO) event according to example embodiments.

FIGS. 8 and 9 are timing diagrams illustrating the scheduling of a re-program method according to example embodiments.

FIG. 10 is a flowchart illustrating a method of operating a storage device according to example embodiments.

FIG. 11 is a flowchart illustrating a backup operation of a storage device according to example embodiments.

FIG. 12 is a flowchart illustrating a program scheduling method of a storage device according to example embodiments.

FIG. 13 is a block diagram of a storage device according to example embodiments.

### DETAILED DESCRIPTION

Hereinafter, example embodiments will be described with reference to the accompanying drawings.

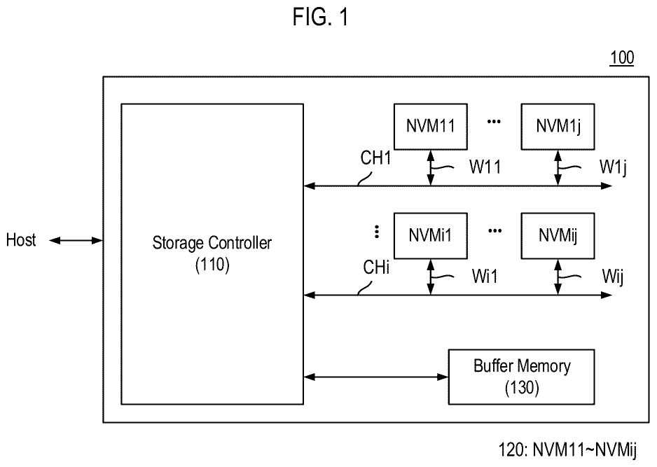

FIG. 1 is a block diagram of a storage device according to example embodiments.

Referring to FIG. 1, a storage device 100 according to example embodiments may include a storage controller 110, a plurality of non-volatile memories 120, and a buffer memory 130.

The storage controller 110 may be configured to control the plurality of non-volatile memories 120 and the buffer memory 130 in response to commands from a host or under the control of the host. For example, the storage controller 110 may write data into the plurality of non-volatile memories 120 or read data stored in the plurality of non-volatile memories 120 in response to a request from the host.

The storage controller 110 may be connected to the plurality of non-volatile memories 120 through a plurality of channels CH1 to CHi and a plurality of ways to access the plurality of non-volatile memories 120. For example, the plurality of channels CH1 to CHi may include i channels. The plurality of ways may be connected to the plurality of channels CH1 to CHi, respectively. In addition, j ways may be provided for each channel, where i and j are the same or different positive integers. For example, a plurality of ways W11 to W1j may be connected to the first channel CH1, and a plurality of ways Wi1 to Wij may be connected to the i-th channel CHi.

A single non-volatile memory may be connected to each of the plurality of ways. For example, a non-volatile memory NVM11 may be connected to the way W11, and a non-volatile memory NVMij may be connected to the way Wij.

The storage controller 110 may transmit and receive signals to and from the plurality of non-volatile memories 120 through the plurality of channels CH1 to CHi. For example, the storage controller 110 may transmit commands, addresses, and data to the plurality of non-volatile memories 120 through the plurality of channels CH1 to CHi or receive data, read from the plurality of non-volatile memories 120, through the plurality of channels CH1 to CHi.

The storage controller 110 may transmit and receive signals to and from the plurality of non-volatile memories 120 in parallel through different channels. In addition, the storage controller 110 may control each of the plurality of non-volatile memories 120 connected to the plurality of channels CH1 to CHi. For example, the storage controller 110 may transmit a command and an address through a single channel, and select and control a single non-volatile memory.

Each of the plurality of non-volatile memories 120 may be connected to one of the plurality of channels CH1 to CHi through a corresponding way. For example, the non-volatile memories NVM11 to NVM1j may be connected to the first channel CH1 through the ways W11 to W1j, and the non-volatile memories NVMi1 to NVMij may be connected to the i-th channel CHi through the ways Wi1 to Wij. For example, each of the plurality of non-volatile memories 120 may be implemented as an arbitrary memory unit, capable of operating in response to individual commands from the storage controller 110. For example, each of the plurality of non-volatile memories 120 may be implemented as a chip or a die, but example embodiments are not limited thereto.

The buffer memory 130 may be a data buffer for data exchange between the storage device 100 and a host connected to the storage device 100. The buffer memory 130 may buffer (for example, temporarily store) write data (i.e., input data) provided from the host or data read from the plurality of non-volatile memories 120.

On a write request from the host, the buffer memory 130 may buffer write data to be stored (for example, programmed) in the plurality of non-volatile memories 120. As another example, on a read request from the host, when data present in the plurality of non-volatile memories 120 is cached, the buffer memory 130 may support a cache function of directly providing the cached data to the host.

For example, the buffer memory 130 may be a volatile memory such as DRAM or SRAM, and may be implemented as synchronous DRAM to provide sufficient buffering performance.

Hereinafter, examples of the storage controller 110 will be described in more detail.

In example embodiments, the storage controller 110 may manage or control a program operation for multi-bit cells included in each of the plurality of non-volatile memories 120. For example, the multi-bit cells may include a single-level cell (SLC), a multilevel cell (MLC), a triple-level cell (TLC), and a quad-level cell (QLC), and may also include cells that may store more bits in a single cell than QLC.

In example embodiments, the storage controller 110 may program write data, which is multi-bit data, in the non-volatile memory through a re-programming method. The re-programming method may be a method of programming the same data N times, where N is a positive integer. For example, N may be a predetermined value.

The storage controller 110 may store data in the buffer memory 130 before performing the re-programming method, and retain the data stored in the buffer memory 130 until the re-programming method is completed (for example, N program operations are completed).

The re-programming method may be performed through a pre-program operation and a re-program operation. The pre-program operation and/or the re-program operation may be performed once or a plurality of times. The sum of the number of executions of the pre-program and re-program operations may be N times in total. The storage controller 110 may pre-program the write data (i.e., input data) into the plurality of non-volatile memories 120. After the pre-program operation is completed, the storage controller 110 may re-program the write data (i.e., the input data) into the plurality of non-volatile memories 120.

In example embodiments, state group data (or digest data) indicating state information of the pre-programmed data may be generated during the pre-program operation (or after the pre-program operation is completed). The state group data may be generated during the pre-program operation or after the pre-program operation is completed.

When the state group data is generated, the storage controller 110 according to example embodiments may back up (or dump) the state group data in the case of a power failure event such as sudden power-off (SPO) event occurring in a period after the pre-program operation is completed and before the re-program operation is performed. The storage controller 110 may recover the write data based on the backed-up state group data, and may perform the re-program operation based on the recovered data. However, when an SPO event occurs during the re-program operation, errors may occur in wordlines that have been pre-programmed due to the SPO event. As a result, the errors occurring in the pre-programmed wordlines may cause difficulty in utilizing the state group data for data recovery.

According to example embodiments, the storage controller 110 may limit the number of ways used for a re-program operation in an arbitrary time period. For example, the storage controller 110 may re-program write data into the plurality of non-volatile memories 120 through a number of ways less than a predetermined threshold value, among the plurality of ways, in an arbitrary time period. For example, the predetermined threshold value may be less than or equal to a total number of the plurality of ways. The storage controller 110 may set a threshold value to limit the number. In other words, the storage controller 110 may set the predetermined threshold value to limit the number of ways used.

During the re-program operation, the storage controller 110 may first pre-program write data according to a write command requested from the host into the plurality of non-volatile memories 120 through the plurality of ways. For example, the pre-program operation performed first may be performed simultaneously through the plurality of ways.

After the pre-program operation is completed, the storage controller 110 may re-program the write data into the plurality of non-volatile memories 120 through different way groups included in the plurality of ways during time periods that do not overlap each other. The way groups represent ways through which a re-program operation is performed in an arbitrary time period, among the non-overlapping time periods, after the pre-program operation is completed. For example, each of the way groups may include a subset of the plurality of ways.

The storage controller 110 may re-program the write data through different way groups for different time periods. Therefore, the re-program operation for different way groups may not be performed redundantly within the same time period.

When a re-program operation is performed a plurality of times according to example embodiments, the storage controller 110 may interleave an arbitrary k-th re-program operation, where k is a positive integer, for different way groups on the time periods. For example, at least re-program operations of the same iteration may not be performed in the same time period. Re-program operations of different iterations may be performed through one or more way groups in an arbitrary time period.

In example embodiments, when the storage controller 110 detects an SPO event in an arbitrary time period among the time periods in which re-program operation is performed, the storage controller 110 may back up write data for one or more way groups. When the number of ways used for re-program operation is limited according to the above-described embodiments, the size of write data to be backed up (backup amount of data or dump amount of data) may depend on a limited number of ways, rather than all ways (for example, a plurality of ways). For example, the backup amount when an SPO event occurs during the re-program operation may be the product of the program unit of a multi-bit cell and the number of ways being re-programmed. The program unit may be the product of a page size, the number of pages, and the number of planes in a non-volatile memory.

Accordingly, the storage controller 110 may limit the number of ways being re-programmed in an arbitrary time period to reduce the size of the write data to be backed up.

According to the above-described embodiments, the storage device 100 may limit the number of ways used for re-program operation to reduce the backup amount of data based on the occurrence of an SPO event during the re-program operation. As the backup amount decreases, the time taken for backup may also decrease.

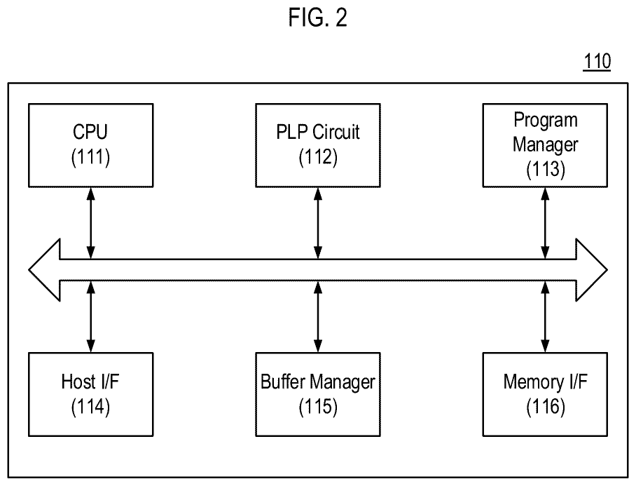

FIG. 2 is a block diagram illustrating an example of the storage controller of FIG. 1 according to example embodiments.

Referring to FIG. 2, the storage controller 110 according to example embodiments may include a central processing unit (CPU) 111, a power loss protection (PLP) circuit 112, a program manager 113, a host interface (I/F) 114, a buffer manager 115, and a memory interface (I/F) 116. Each component in the storage controller 110 may be connected through a system bus.

The CPU 111 may include a processing unit such as a microprocessor. The CPU 111 may control the overall operation of the storage controller 110. The CPU 111 may drive firmware for driving the storage controller 110. For example, the CPU 111 may execute various types of firmware loaded into a code memory (not illustrated).

In example embodiments, when the program manager 113 is provided as a software module, the CPU 111 may execute a software module corresponding to the program manager 113 to perform operations of the storage controller 110 according to example embodiments, including a program operation of data. As the program manager 113 is executed, the CPU 111 may generate various types of control information necessary for implementing a re-program policy and interleaving the re-program operation.

In example embodiments, the CPU 111 may include a plurality of cores. Each of the plurality of cores may be implemented as an individual processor core. The plurality of cores may include a host core, a flash translation layer (FTL) core, and/or a NAND core.

The host core may be defined as a core inside the storage device performing operations related to a host interface layer (HIL). For example, the host core may process a request input from the host through the host interface 114.

The FTL core may be defined as a core inside the storage device performing operations related to the FTL. For example, the FTL core may control the NAND core such that a read operation, a write operation, or an erase operation may be performed by the non-volatile memory based on the request received from the host core. As another example, the FTL core may perform an address mapping operation of mapping a logical block address (LBA) transmitted from the host to a physical block address (PBA), a physical location of the non-volatile memory, using the FTL.

The NAND core may be defined as a core inside the storage device performing operations related to the flash interface layer (FIL). For example, the NAND core may control the memory interface 116 to perform operations on the non-volatile memory under the control of the FTL core. For example, the NAND core may control the memory interface 116 based on a queue for controlling the non-volatile memory. A command for controlling the non-volatile memory may be queued through a queue.

The PLP circuit 112 may monitor external power and detect power failure events such as an SPO event. When an SPO event occurs, the PLP circuit 112 may detect the SPO event and may generate a detection signal based on the detection and provide the detection signal to the program manager 113.

The program manager 113 may generate, set, and manage a re-program policy. In example embodiments, the re-program policy may set or indicate the maximum number of ways that may be activated during a single re-program operation (for example, a k-th reprogram operation when plurality of re-program operation should be performed) (for example, the number of ways within a way group). As another example, the re-program policy may set or indicate the number of ways included in each of the way groups. As a further example, the re-program policy may set or indicate the number of way groups. For example, the number of way groups may be two (2), but example embodiments are not limited thereto.

The program manager 113 may statically or dynamically schedule a re-program operation on the way groups or set the number of ways included in each of the way groups, based on the re-program policy.

The program manager 113 may re-program the write data through one or more way groups, among the way groups, in an arbitrary time period after the pre-program operation, based on the re-program policy. When a re-program operation is performed through a plurality of way groups, the program manager 113 may schedule the re-program operation to perform different re-programs through different way groups for an arbitrary time period.

In example embodiments, the program manager 113 may monitor a program progress for a plurality of channels and a plurality of ways according to the re-program policy. The program manager 113 may dequeue a command from a queue for controlling the plurality of non-volatile memories for the program operation. For example, the command may request to program write data for one or more way groups. The command may indicate a pre-program operation or a re-program operation. The program manager 113 may perform a pre-program operation when indicated by the command.

As another example, when the command does not indicate a pre-program operation, the program manager 113 may check the number of ways (e.g., may determine the number of ways), in which a re-program operation is being performed, among the plurality of ways. When the number of ways is greater than or equal to a predetermined threshold value (for example, the maximum number of ways indicated through the re-program policy), the program manager 113 may enqueue the command into a pending queue. The program manager 113 may continuously monitor a program state. When the number of ways decreases to less than the predetermined threshold value, the program manager 113 may dequeue the command from the pending queue again to perform re-program operation.

When the number of ways is less than the threshold value, the program manager 113 may perform a re-program operation immediately.

When receiving a detection signal from the PLP circuit 112, the program manager 113 may suspend the program operation being performed. Then, the program manager 113 may back up the data stored in the buffer memory (see the buffer memory 130 in FIG. 1) to the non-volatile memory through the memory interface 116.

In example embodiments, when an SPO event is detected during a re-program operation, the program manager 113 may back up the write data to be re-programmed into the non-volatile memory through the ways that were being re-programmed (or the ways in which the re-program operation was scheduled). For example, when an SPO event is detected in an arbitrary time period after a pre-program operation, the program manager 113 backs up only the write data to be re-programmed into the non-volatile memory through a limited number of ways.

In example embodiments, an additional command may be requested from the host through the host interface 114. For example, the additional command may be to request writing of additional write data. After the re-program operation on a single way group, among the way groups, is completed, the program manager 113 may pre-program the additional write data in the plurality of non-volatile memories through the single way group. For example, the program manager 113 may start the pre-program operation on the additional write data and the re-program operation on the write data together in any period among the time periods.

As a result, a pre-program operation and a re-program operation on different way groups may be performed in parallel in an arbitrary time period.

The host interface 114 may provide an interface between the host and the storage controller 110. The host and the storage controller 110 may be connected through a single interface among various standardized interfaces. The standard interfaces may include various interface schemes such as an advanced technology attachment (ATA), a serial ATA (SATA), an external SATA (e-SATA), a small computer small interface (SCSI), a serial attached SCSI (SAS), a peripheral component interconnection (PCI), a PCI-express (PCIe), a universal serial bus (USB), IEEE 1394, a universal flash storage (UFS), or a card interface.

The buffer manager 115 may control the read and write operations of the buffer memory (see the buffer memory 130 of FIG. 1). For example, the buffer manager 115 may buffer write data or read data in the buffer memory under the control of the CPU 111 or the program manager 113. The buffer manager 115 may buffer the write data, corresponding to the program operation at the time of SPO occurrence, in the buffer memory when an SPO event occurs.

In example embodiments, when an SPO event occurs during a pre-program operation, the buffer manager 115 may buffer the write data to be pre-programmed into the buffer memory. In example embodiments, the buffer manager 115 may buffer the state group data in the buffer memory when an SPO event occurs after the pre-program operation is completed. In example embodiments, when an SPO event occurs during a re-program operation, the buffer manager 115 may back up only the write data to be re-programmed into the non-volatile memory through a limited number of ways.

The memory interface 116 may provide interfacing between the storage controller 110 and the non-volatile memory. For example, data processed by the CPU 111 may be stored in the non-volatile memory through the memory interface 116. For example, write data to be backed up may be backed up in the non-volatile memory through the memory interface 116.

According to the above-described embodiments, the storage device may limit the number of ways used for a re-program operation based on the re-program policy to reduce the amount of backup and the time taken for backup due to the occurrence of an SPO event during the re-program operation.

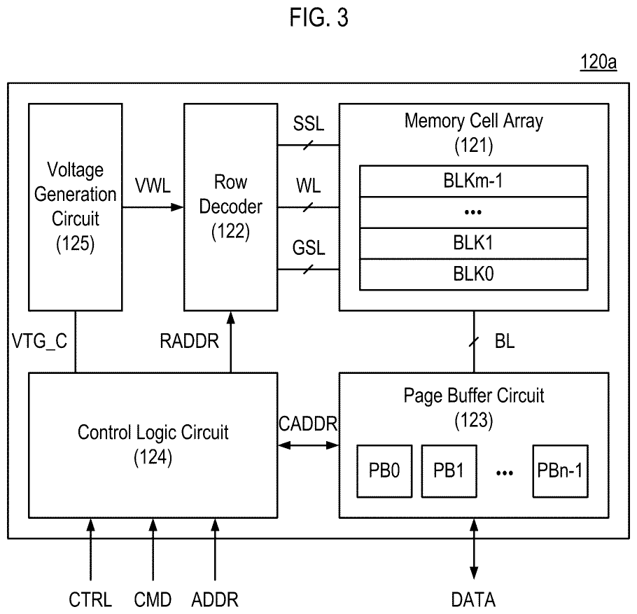

FIG. 3 is a block diagram illustrating an example of a non-volatile memory of FIG. 1 according to example embodiments.

Referring to FIG. 3, a non-volatile memory 120a may include a memory cell array 121, a row decoder 122, a page buffer circuit 123, a control logic circuit 124, and a voltage generation circuit 125. Although not illustrated in FIG. 3, the non-volatile memory 120a may further include a data input/output circuit, an input/output interface, and/or the like. The non-volatile memory 120a may further include components such as column logic, a pre-decoder, a temperature sensor, a command decoder, and/or an address decoder. In addition, the non-volatile memory 120a may be one of the plurality of non-volatile memories 120 illustrated in FIG. 1.

The memory cell array 121 may include a plurality of memory blocks BLK0 to BLKm-1, where m is a positive integer. Each of the plurality of memory blocks BLK0 to BLKm-1 may include a plurality of memory cells. The plurality of memory blocks BLK0 to BLKm-1 may be included in a single memory plane, but example embodiments are not limited thereto. The memory cell array 121 may be connected to the page buffer circuit 123 through bitlines BL, and may be connected to the row decoder 122 through wordlines WL, string select lines SSL, and ground select lines GSL.

In example embodiments, the memory cell array 121 may include a three-dimensional (3D) memory cell array 121. The 3D memory array 121 may include a plurality of levels, and may have wordlines or bitlines shared between the levels.

The row decoder 122 may select a single memory block, among memory blocks of the memory cell array 121, in response to a row address RADDR. The row decoder 122 may select a single wordline, among wordlines of a selected memory block, in response to the row address RADDR. The row decoder 122 may transmit a voltage VWL corresponding to an operation mode to the wordline of the selected memory block. During a program operation, the row decoder 122 may transmit a program voltage and a verify voltage to the selected wordline and transmit a pass voltage to unselected wordlines. During a read operation, the row decoder 122 may transmit a read voltage to a selected wordline and transmit a read pass voltage to unselected wordlines.

The page buffer circuit 123 may include a plurality of page buffers PB0 to PBn-1. The plurality of page buffers PB0 to PBn-1 may be connected to memory cells through a plurality of bitlines BL, respectively. The page buffer circuit 123 may select at least one bitline, among the bitlines BLs, in response to a column address CADDR. The page buffer circuit 123 may operate as a write driver or a sense amplifier depending on an operation mode. For example, during a program operation, the page buffer circuit 123 may apply a bitline voltage corresponding to the data (DATA) to be programmed to the selected bitline. During a read operation, the page buffer circuit 123 may sense a current or voltage of the selected bitline to detect data (DATA) stored in the memory cell.

The control logic circuit 124 may control overall operations within the non-volatile memory 120a. The control logic circuit 124 may output various control signals for programming data in the memory cell array 121, reading data from the memory cell array 121, or erasing data stored in the memory cell array 121 in response to a control signal CTRL, a command CMD, and/or an address ADDR. For example, the control logic circuit 124 may output a voltage control signal VTG_C, an address (e.g., a row address RADDR and a column address CADDR), and/or the like.

In example embodiments, the control logic circuit 124 may output control signals for programming multi-bit data according to the received control signal CTRL, command CMD, and/or address ADDR. For example, the control logic circuit 124 may output control signals for a pre-program operation and a re-program operation, output control signals for backing up state group data, or output control signals for reading pre-programmed or re-programmed multi-bit data.

The voltage generation circuit 125 may generate various types of voltages for performing program, read, and erase operations based on the voltage control signal VTG_C. For example, the voltage generation circuit 125 may generate a program voltage, a read voltage, a program verify voltage, or the like, as a wordline voltage VWL. For example, the program voltage may be generated by an incremental step pulse program (ISPP) scheme.

In a program operation on multi-bit data, the voltage generation circuit 125 may generate a pre-program verify voltage for pre-program operation and a re-program verify voltage for re-program operation. The pre-program verify voltage may be lower than the re-program verify voltage.

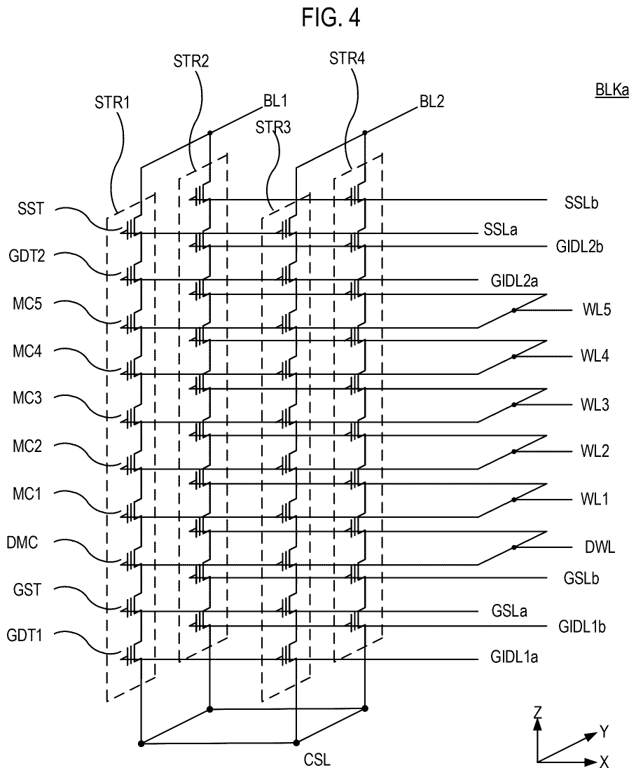

FIG. 4 is a circuit diagram illustrating an example of a memory block within a memory cell array of FIG. 1 according to example embodiments. For ease of description, an example is provided in which a single memory block includes four strings STR1 to STR4.

Referring to FIG. 4, a memory block BLKa may include a plurality of strings STR1 to STR4, vertically stacked on a substrate. Each of the plurality of strings STR1 to STR4 may be disposed in a first direction (X-axis direction) and a second direction (Y-axis direction). For example, the memory block BLKa may be one of the plurality of memory blocks BLK0 to BLKm-1 illustrated in FIG. 3, although example embodiments are not limited thereto.

Strings located in the same column, among the plurality of strings STR1 to STR4, may be connected to the same bitline. For example, the first and second strings STR1 and STR2 may be connected to a first bitline BL1, and the third and fourth strings STR3 and STR4 may be connected to a second bitline BL2.

Each of the plurality of strings STR1 to STR4 may include a plurality of cell transistors. Each of the plurality of cell transistors may be a charge-trap flash (CTF) memory cell, but example embodiments are not limited thereto. The plurality of cell transistors may be stacked in a third direction (Z-axis direction).

The plurality of strings STR1 to STR4 may be commonly connected to a common source line CSL. For example, as illustrated in FIG. 4, a common source line CSL may be commonly connected to lower ends of the plurality of strings STR1 to STR4. However, this is only an example, and it is sufficient for the common source line CSL to be electrically connected to the lower ends of the strings STR1 to STR4, and it is not limited to being physically located at the lower ends of the strings STR1 to STR4. Hereinafter, for ease of description, the structure and configuration of a string will be described based on the first string STR1. The other strings STR2, STR3, and STR4 may have a similar structure to the first string STR1, and thus a detailed description thereof will be omitted.

The plurality of cell transistors may be connected in series between the first bitline BL1 and the common source line CSL. For example, the plurality of cell transistors may include gate-induced drain leakage (GIDL) transistors GDT1 and GDT2, a string select transistor SST, memory cells MC1 to MC5, a dummy memory cell DMC, and ground select transistors GST.

The first GIDL transistor GDT1 may be disposed at a lowermost end of the string STR1. For example, the first GIDL transistor GDT1 may be connected to the common source line CSL at a lower end of the string STR1. However, this is only an example, and example embodiments are not limited thereto. A gate of the first GIDL transistor GDT1 may be connected to a first GIDL line GIDL1a.

The second GIDL transistor GDT2 may be disposed at an upper end of the string STR1, and may be disposed between the string select transistor SST and the memory cell MC5. For example, the second GIDL transistor GDT2 may be connected to the first bitline BL1 through the string select transistor SST. A gate of the second GIDL transistor GDT2 may be connected to a second GIDL line GIDL2a.

In FIG. 4, the GIDL transistors GDT1 and GDT2 are illustrated as being provided at the upper and lower ends of the string STR1. However, this is only an example. In some embodiments, the GIDL transistor may be provided only at the upper end or only at the lower end of the string STR1.

A single string select transistor SST may be disposed at the uppermost end of a string STR1. The string select transistor SST may be connected to the first bitline BL1 at the uppermost end of the string STR1. A gate of the string select transistor SST may be connected to a string select line SSLa. However, this is only an example. In some embodiments, a plurality of string select transistors connected in series may be provided between the first bitline BL1 and the second GIDL transistor GDT2.

A single ground select transistor GST may be provided between a dummy memory cell DMC and the first GIDL transistor GDT1. A gate of the ground select transistor GST may be connected to the ground select line GSLa. However, this is only an example. In some embodiments, a plurality of ground select transistors connected in series may be provided between the dummy memory cell DMC and the first GIDL transistor GDT1.

The first to fifth memory cells MC1 to MC5 may be connected in series between the string select transistor SST and the dummy memory cell DMC. Gates of each of the first to fifth memory cells MC1 to MC5 may be connected to the first to fifth wordlines WL1 to WL5.

A single dummy memory cell DMC may be provided between the first memory cell MC1 and the first GIDL transistor GDT1. A gate of the dummy memory cell DMC may be connected to a dummy wordline DWL. However, this is only an example. In some embodiments, a plurality of dummy memory cells connected in series may be provided between the first memory cell MC1 and the first GIDL transistor GDT1. As another example, an additional dummy memory cell may be provided between the string select transistor SST and the fifth memory cell MC5. As a further example, an additional dummy memory cell may be provided between the memory cells MC1 to MC5. As yet another example, the dummy memory cell DMC may not be provided.

According to example embodiments, a program voltage may be applied to the gates of each of the first to fifth memory cells MC1 to MC5 through the first to fifth wordlines WL1 to WL5, and a pre-program operation or a re-program operation may be performed through the application of the program voltage.

After pre-program operation is completed through the first to fifth wordlines WL1 to WL5, SPO may occur in a storage device during a re-program operation. The occurrence of an SPO event may cause errors in the first to fifth wordlines WL1 to WL5, and the errors may make it difficult to recover pre-programmed data.

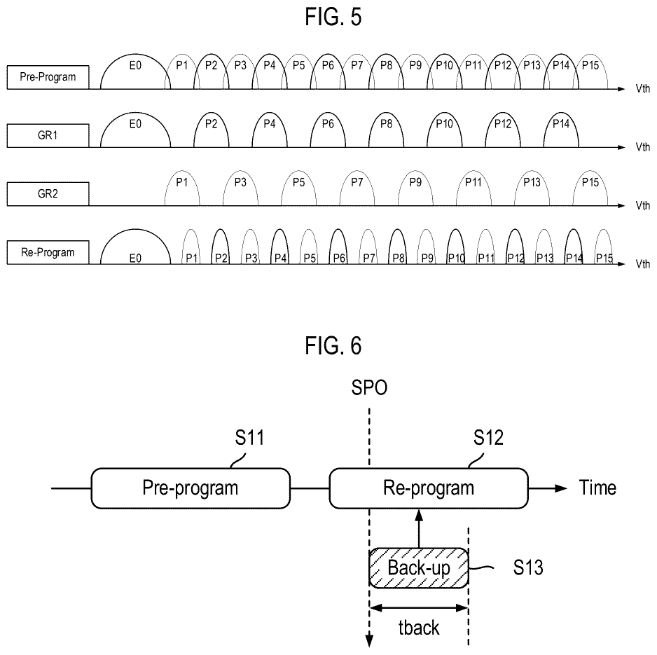

FIG. 5 is a diagram illustrating data states based on a pre-program operation and a re-program operation according to example embodiments.

Referring to FIG. 5, when a program operation starts, a storage device according to example embodiments may pre-program (or coarse-program) multi-bit data in memory cells of a non-volatile memory. For example, when the multi-bit data is 4-bit data (for example, when the memory cell is QLC), the pre-programmed memory cell may have a threshold voltage (Vth) corresponding to a single state among 16 threshold voltage states E0 and P1 to P15, as illustrated in FIG. 5. The 16 threshold voltage states E0 and P1 to P15 may correspond to the 16 values that the multi-bit data may have, respectively. For example, the pre-programmed memory cell may correspond to one of the 16 threshold voltage states E0 and P1 to P15 based on a multi-bit data value. The threshold voltages of the memory cells may fluctuate due to capacitive coupling between adjacent memory cells, leading to an increase in width of the threshold voltage distribution. Accordingly, adjacent threshold voltage distributions may overlap each other.

The threshold voltage distributions of the pre-programmed memory cells may be divided into a plurality of state groups. For example, threshold voltage states corresponding to the erase state E0 and the program states P1 to P15 may be divided into a first state group GR1 and a second state group GR2.

In example embodiments, each of the state groups may include different threshold voltage distributions, and the threshold voltage distributions of each of the state groups may not overlap each other. For example, the first state group GR1 may include threshold voltage distributions corresponding to the erase state E0, the second program state P2, the fourth program state P4, the sixth program state P6, the eighth program state P8, the tenth program state P10, the twelfth program state P12, and the fourteenth program state P14. The second state group GR2 may include threshold voltage distributions corresponding to the first program state P1, the third program state P3, the fifth program state P5, the seventh program state P7, the ninth program state P9, the eleventh program state P11, the thirteenth program state P13, and the fifteenth program state P15.

The number of state groups is only an example, and example embodiments are not limited thereto.

Each of the state groups may be represented by state group data.

For example, when the threshold voltage distributions are divided into four state groups, the state group data may be 2-bit data. For example, the number of bits of the state group data may be smaller than the number of bits of the multi-bit data.

The pre-programmed multi-bit data may correspond to state group data indicating one of the plurality of state groups according to the data value. For example, multi-bit data corresponding to the erase state E0 may correspond to state group data indicating the first state group GR1, and multi-bit data corresponding to the first program state P1 may correspond to state group data indicating the second state group GR2.

When SPO occurs after pre-program operation is completed, the storage device may back up state group data corresponding to the pre-programmed memory cells in the non-volatile memory. For example, when multi-bit data corresponding to the first program state P1 is pre-programmed, the storage device may back up state group data indicating the second state group GR2 corresponding to the pre-programmed memory cell in the non-volatile memory.

When power is restored from the SPO, the storage device may recover the multi-bit data based on the backed-up state group data. For example, the storage device may read the multi-bit data from the pre-programmed memory cell based on the state group data. As illustrated in FIG. 5, even when there is an overlapping area in the threshold voltage distributions of the pre-programmed memory cells, a read operation performed on each state group based on the state group data may determine which threshold voltage distribution the overlapping area belongs to. Accordingly, the reliability of the recovered multi-bit data may be improved.

The storage device may re-program (or fine-program) the multi-bit data in the memory cell based on the recovered multi-bit data. The program operation on the multi-bit data may be completed by the re-program operation. As illustrated in FIG. 5, a width of the threshold voltage distribution of the memory cells may be decreased by performing the re-program operation.

The fluctuation range of a program voltage for a re-program operation may be lower than the fluctuation range of a program voltage for a pre-program operation. For example, the storage device may perform the re-program operation based on injecting a program voltage having a smaller fluctuation range.

Due to the difference in the fluctuation range of the program voltage, an increase in the threshold voltage of a memory cell caused by a re-program operation may be smaller than an increase in the threshold voltage of a memory cell caused by a pre-program operation. Therefore, the threshold voltage distribution based on the re-program operation may be less affected by coupling, resulting in narrower threshold voltage distributions for the memory cells and a reduced overlapping area according to the re-program operation. Accordingly, when multi-bit data is read from the re-programmed memory cell, the reliability of the multi-bit data may be improved.

In example embodiments, a re-program verify voltage for re-program operation multi-bit data may be higher than a pre-program verify voltage for pre-program operation multi-bit data. For example, the re-program verify voltage applied to any program state in the re-program operation may be higher than the pre-program verify voltage applied to any program state in the pre-program operation. For example, the pre-program operation may be performed using a pre-program verify voltage corresponding to a threshold voltage lower than a required threshold voltage. During the re-program operation, the memory cell may be programmed to the required threshold voltage using the re-program verify voltage higher than the pre-program verify voltage.

Although FIG. 5 illustrates threshold voltage states resulting from a single re-program operation, example embodiments are not limited thereto. For example, a re-program operation may be performed several times to generate a finer threshold voltage.

When SPO occurs during a re-program operation, backup of write data corresponding to program states resulting from the re-program operation may be needed. According to the above-described embodiments, the storage device may limit the number of ways used for the re-program operation to reduce the backup amount and backup time.

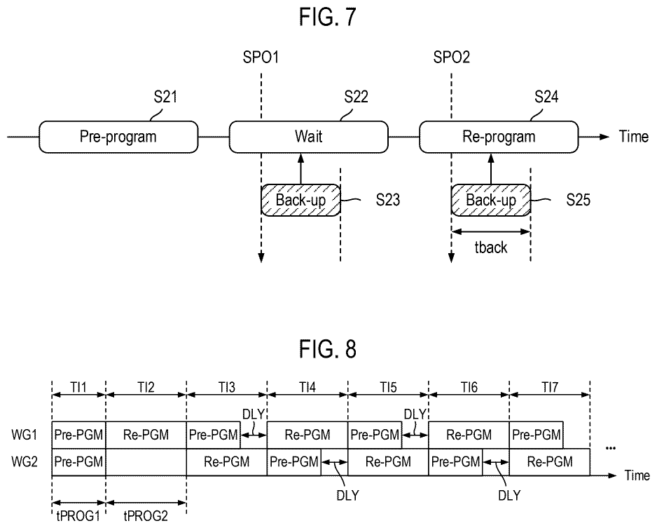

FIGS. 6 and 7 are timing diagrams illustrating backup operations during an SPO event according to example embodiments.

Referring to FIG. 6, in operation S11, a storage device performs a pre-program operation. For example, when the write data is 4-bit data, a memory cell programmed through pre-program operation may have a threshold voltage corresponding to a single state among 16 threshold voltage states (for example, E0 and P1 to P15 resulting from the pre-program operation in FIG. 5).

In example embodiments, state group data may be generated through a pre-program operation.

After completing the pre-program operation in operation S11, operation S12 may be performed in which the storage device performs a re-program operation. When operation S12 is normally completed, a memory cell programmed through the re-program operation may have a threshold voltage corresponding to one of the 16 threshold voltage states (for example, E0 and P1 to P15 resulting from the re-program operation in FIG. 5).

When an SPO event occurs during operation S12, operation S13 may be performed in which the storage device performs backup on write data to be re-programmed. When the number of ways that may be re-programmed is limited according to example embodiments, the backup in operation S13 may be performed only on the write data to be re-programmed through the limited number of ways.

Therefore, compared to the case in which all of the plurality of ways are re-programmed, backup time (tback) in the case in which a re-program operation is performed in a limited number of ways according to example embodiments may be further reduced.

Referring to FIG. 7, in operation S21, the storage device performs a pre-program operation.

In operation S22, the storage device has a waiting time before performing the re-program operation.

In example embodiments, when SPO1 occurs during the waiting time (i.e., when a first SPO event SPO1 occurs during the waiting time), operation S23 may be performed in which the storage device may back up state group data generated through operation S21. According to example embodiments, the storage device may also perform recovery of the write data based on the backed-up state group data and the pre-programmed data.

In operation S24, the storage device performs re-program operation. When SPO1 has occurred according to example embodiments, the storage device may perform a re-program operation based on the recovered data.

In example embodiments, when SPO2 occurs during the re-program operation (i.e., when a second SPO event SPO2 occurs during the re-program operation), operation S25 may be performed in which the storage device performs backup on write data to be re-programmed. According to the above-described embodiments, the backup according to operation S25 may be performed only on the write data to be re-programmed through the limited number of ways. Accordingly, the backup time (tback) may be further reduced.

The occurrence of SPO2 during the re-program operation may cause an error in the pre-program operation. The state group data generated through the pre-program operation is unavailable due to the error, so that the backup for the write data to be re-programmed may be needed. Nevertheless, the backup amount for the write data to be re-programmed may be reduced according to the above-described embodiments, so that the backup during re-program operation may be performed more rapidly.

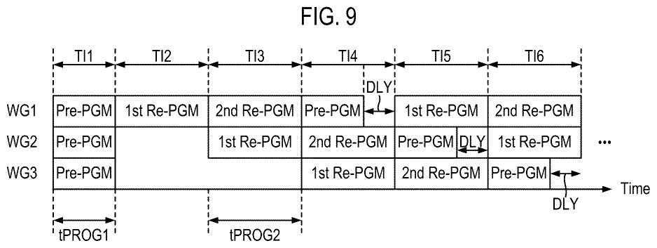

FIGS. 8 and 9 are timing diagrams illustrating the scheduling of a re-program method according to example embodiments.

Referring to FIG. 8, a storage device according to example embodiments may schedule start times of a re-program operation such that the re-program operation is performed through different way groups during first to seventh time periods TI1 to TI7 that do not overlap each other. Although two way groups are illustrated as an example in FIG. 8, example embodiments are not limited thereto. A program time of re-program operation tPROG2 may be greater than or equal to a program time of pre-program operation tPROG1.

According to the scheduling of the start times of the re-program operation (Re-PGM), a re-program operation on a first way group WG1 and a re-program operation on a second way group WG2 may be performed in different time periods. For example, a re-program operation on different way groups may not be performed simultaneously.

In the re-program operation method according to example embodiments, write data may be pre-programmed (Pre-PGM) in a non-volatile memory through the first way group WG1 and the second way group WG2 during the first time period TI1.

When the first time period TI1 ends, the write data may be re-programmed in the non-volatile memory through the first way group WG1 during the second time period TI2. The re-program operation on the second way group WG2 may be suspended during the second time period TI2.

When the second time period TI2 ends, a re-program operation may be performed in the non-volatile memory through the second way group WG2 during the third time period TI3. When a program operation on additional write data according to an additional command is requested, a pre-program operation on the first way group WG1 may be performed along with a re-program operation on the second way group WG2. For example, a re-program operation on the write data through the second way group WG2 and a pre-program operation on the additional write data through the first way group WG1 may simultaneously start during the third time period T13. For example, the storage controller 110 (see FIGS. 1 and 2) may simultaneously initiate the re-program operation on the write data through the second way group WG2 and the pre-program operation on the additional write data through the first way group WG1 during the third time period T13.

When there is a difference between the program time of the re-program operation tPROG2 and the program time of the pre-program operation tPROG1, there may be a delay interval DLY. When the pre-program operation on the first way group WG1 is completed, the first way group WG1 may wait for a delay interval DLY.

When the third time period TI3 ends, a re-program operation is performed through the first way group WG1 during the fourth time period TI4. At the same time, a pre-program operation may be performed through the second way group WG2.

Then, performing a pre-program operation in one way group and performing a re-program operation in another way group may be repeated during the fifth to seventh time periods TI5 to TI7. Due to scheduling, the re-program operation is not performed on both the first way group WG1 and the second way group WG2 simultaneously during the second to seventh time periods TI2 to TI7.

Accordingly, when an SPO event is detected in an arbitrary time period among the second to seventh time periods TI2 to TI7, backup may be performed only on write data to be re-programmed in any one way group. For example, when the SPO event is detected during the second time period TI2, the storage device may back up the write data to be re-programmed in the first way group WG1.

Referring to FIG. 9, a re-program operation may be performed a plurality of times according to example embodiments. In FIG. 9, the re-program operation is illustrated as being performed twice in a single re-program operation method, but example embodiments are not limited thereto.

When the re-program operation is performed a plurality of times, the storage device according to example embodiments may schedule the start times of the re-program operation such that re-program operations of different iterations (for example, a first re-program operation (1st Re-PGM) and a second re-program operation (2nd Re-PGM)) are performed through different way groups during the first to sixth time periods TI1 to TI6 that do not overlap each other. Although three way groups are illustrated as an example in FIG. 9, example embodiments are not limited thereto. A program time of each re-program operation tPROG2 may be greater than or equal to a program time of the pre-program operation tPROG1. In addition, the program times of the first re-program operation and the second re-program operation are illustrated as being the same, but may be different from each other in some embodiments.

According to the scheduling of the start times of re-program operation, a k-th re-program operation on a first way group WG1 and a k-th re-program operation on a second way group WG2 may be performed in different time periods. For example, re-program operations of the same iteration are not performed simultaneously on different way groups. For example, a first re-program operation may not be performed by different ones of the first to third way groups WG1 to WG3 during a same time period among the first to sixth time periods TI1 to TI6. Said another way, the first re-program operation may be performed by only one of the first to third way groups WG1 to WG3 during a given one of the first to sixth time periods TI1 to TI6. As another example, a second re-program operation may not be performed by different ones of the first to third way groups WG1 to WG3 during a same time period among the first to sixth time periods TI1 to TI6.

In the re-program operation method according to example embodiments, write data may be pre-programmed (Pre-PGM) in a non-volatile memory through first to third way groups WG1 to WG3 during a first time period TI1.

When the first time period TI1 ends, a first re-program operation may be performed through the first way group WG1 during a second time period TI2. The first re-program operation on the second way group WG2 may be suspended during a second time period TI2.

When the second time period TI2 ends, the first re-program operation may be performed through the second way group WG2 during a third time period TI3. At the same time, the second re-program operation may be performed through the first way group WG1. The first re-program operation on the third way group WG3 may be suspended during the second time period TI2 to the third time period TI3.

When a program operation on additional write data based on an additional command is requested, a pre-program operation on the first way group WG1 may be performed along with the second re-program operation on the second way group WG2 and the first re-program operation on the third way group WG3. For example, the re-program operation on the write data through the second way group WG2 and the third way group WG3 and the pre-program operation on the additional write data through the first way group WG1 may start simultaneously during a fourth time period TI4.

When there is a difference between a program time of the re-program operation tPROG2 and a program time of the pre-program operation tPROG1, there may be a delay period DLY. In addition, there may be a delay period even between re-program operations of different iterations. In this case, the remaining way groups may wait until a longest re-program operation is completed.

When the fourth time period TI4 ends, performing a pre-program operation in one way group and performing re-program operations of different iterations in other way groups may be repeated during fifth to sixth time periods TI5 to TI6. Due to scheduling, re-program operations of the same iteration are not performed simultaneously on the first to third way groups during the second to sixth time periods TI2 to TI6.

Accordingly, when an SPO event is detected in an arbitrary time period among the second to sixth time periods TI2 to TI6, backup may be performed only on the write data to be re-programmed in some way groups. In this case, the backup amount may be reduced compared to the case in which a re-program operation is scheduled for all way groups.

Unlike the illustration of FIG. 9, the storage device according to some other example embodiments may schedule a program operation on the way groups such that only one re-program operation is performed in an arbitrary time period after an initial pre-program operation is completed, regardless of the iteration of re-program operation.

As another example, the storage device according to example embodiments may schedule a program operation on the way groups such that one or more of first to K-th re-program operations, where K is a positive integer, are performed in an arbitrary time period after the initial pre-program operation is completed.

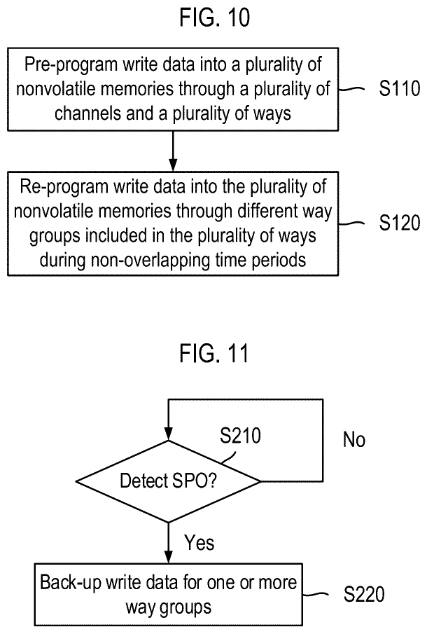

FIG. 10 is a flowchart illustrating a method of operating a storage device according to example embodiments. In some embodiments, a storage controller included in the storage device may be configured to perform one or more of the operations illustrated in FIG. 10.

Referring to FIG. 10, in operation S110, the storage device may pre-program write data into a plurality of non-volatile memories through a plurality of channels and a plurality of ways. For example, the pre-program operation may be simultaneously started on the plurality of ways.

After operation S110 is completed, the method proceeds to operation S120 in which the storage device may re-program the write data into the plurality of non-volatile memories through different way groups included in the plurality of ways during time periods that do not overlap each other. The storage device may re-program the write data through one or more of the way groups in an arbitrary time period among the time periods. For example, when a single re-program operation is required, the write data may be re-programmed through a single way group in an arbitrary time period.

For example, when a plurality of re-program operations are required, a k-th re-program operation may be performed through a single way group in an arbitrary time period, or re-program operations of different iterations may be performed simultaneously through a plurality of way groups in an arbitrary time period.

According to the above-described method, the number of ways being re-programmed is limited, so that the backup amount caused by an SPO event may be reduced.

FIG. 11 is a flowchart illustrating a backup operation of a storage device according to example embodiments. In some embodiments, a storage controller included in the storage device may be configured to perform one or more of the operations illustrated in FIG. 11.

Referring to FIG. 11, in operation S210, the storage device may detect an SPO event for the storage device. For example, the storage device may detect the SPO event by monitoring external power. When an SPO event is not detected, an SPO detection operation through operation S210 may be repeatedly performed.

When an SPO event is detected in an arbitrary time period through operation S210, operation S220 may be performed in which the storage device may back up write data for one or more way groups. The one or more way groups are way groups being re-programmed.

According to the above-described backup operation, the backup amount may be reduced compared to the case in which write data for all way groups is backed up.

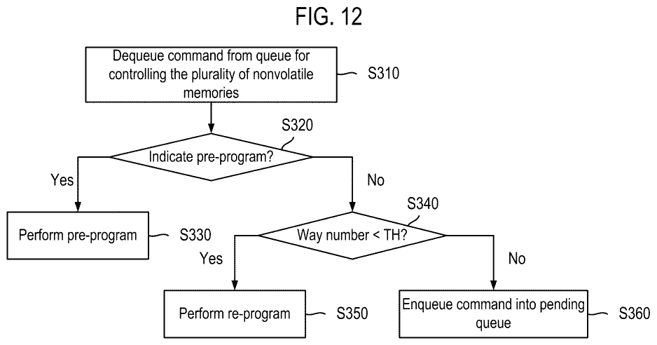

FIG. 12 is a flowchart illustrating a program scheduling method of a storage device according to example embodiments. In some embodiments, a storage controller included in the storage device may be configured to perform one or more of the operations illustrated in FIG. 12.

Referring to FIG. 12, in operation S310, the storage device may dequeue a command from a queue for controlling a plurality of non-volatile memories. For example, the command may be received from a host and may be used to control the plurality of non-volatile memories.

In operation S320, the storage device may check whether the command dequeued in operation S310 indicates a pre-program operation. When the dequeued command indicates a pre-program operation, the method proceeds to operation S330 in which the storage device may perform the pre-program operation.

When the dequeued command does not indicate a pre-program operation, the method proceeds to operation S340 in which the storage device checks the number of ways in which the re-program operation is being performed, among a plurality of ways.

When the number of ways is less than a threshold value (TH), the method proceeds to operation S350 in which the storage device performs a re-program operation. For example, the threshold value may be a predetermined threshold value.

When the number of ways is greater than or equal to a predetermined threshold value (TH), the method proceeds to operation S360 in which the storage device enqueues the command into a pending queue.

According to the above-described method, simultaneous re-programming through more than a limited number of ways may be prevented to reduce the backup amount when an SPO event occurs during the re-program operation.

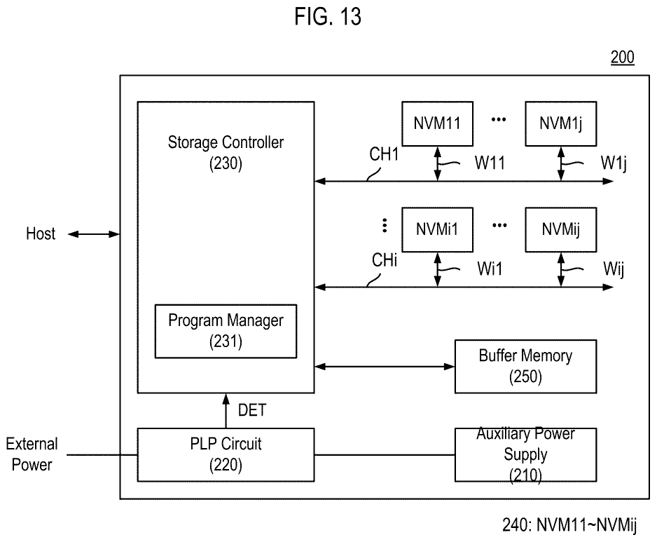

FIG. 13 is a block diagram of a storage device according to example embodiments.

Referring to FIG. 13, a storage device 200 according to example embodiments may include an auxiliary power supply 210, a PLP circuit 220, a storage controller 230, a plurality of non-volatile memories 240, and a buffer memory 250.

The auxiliary power supply 210 may supply accumulated energy to the storage device 200 in the event of SPO in which external power is cut off. The storage device 200 may complete an operation being performed and perform a data backup operation using energy from the auxiliary power supply 210. The more backup amount, the more energy accumulation may be needed in the auxiliary power supply 210.

The PLP circuit 220 may be configured to prevent loss of power supplied to the storage device 200. The PLP circuit 220 may be implemented as an integrated circuit (IC), a chip, or an element. In a situation in which external power is normally supplied, the PLP circuit 220 may supply the external power as power used by the storage device 200. When the external power is cut off, the PLP circuit 220 may provide an output of the auxiliary power supply 210 as power used by the storage device 200.

The PLP circuit 220 may detect an SPO event such as a cutoff of external power or a severe voltage drop. When the SPO event is detected, the PLP circuit 220 may provide a power-off detection signal DET to the storage controller 230. In addition, the PLP circuit 220 may switch a source of power for driving the storage device 200 from external power to the auxiliary power supply 210.

The storage controller 230 may be configured to control the plurality of non-volatile memories 240 and the buffer memory 250 according to commands or controls from a host. For example, the storage controller 230 may write data into the plurality of non-volatile memories 240 or read data stored in the plurality of non-volatile memories 240, in response to a request from the host. The storage controller 230 may provide commands, addresses, data and control signals to the plurality of non-volatile memories 240 to access the plurality of non-volatile memories 240.

The storage controller 230 may perform a program operation according to the above-described embodiments through the program manager 231. For example, the storage controller 230 may generate various types of control information necessary for a re-program policy and interleaving of the re-program through the program manager 231. The storage controller 230 may schedule the re-program operation such that the re-program operation is performed through different way groups during different time periods.

The storage controller 230 may pre-program the write data into the plurality of non-volatile memories 240 through a plurality of channels CH1 to CHi and a plurality of ways W11 to Wij. When the pre-program operation is completed, the storage controller 230 may re-program the write data into the plurality of non-volatile memories 240 through different way groups. The storage controller 230 may schedule the program such that the number of ways activated for the re-program operation is not greater than the maximum number set through the re-program policy.

For example, when a command for controlling the plurality of non-volatile memories 240 indicates a re-program operation, the storage controller 230 may check whether the number of activated ways when the re-program operation is additionally performed according to the command is greater than the maximum number. When the number of activated ways is greater than the maximum number, the storage controller 230 may suspend performance of the re-program operation according to the command.

When an SPO event is detected by the PLP circuit 220 during the re-program operation, the storage controller 230 may back up only the write data for the activated ways to the plurality of non-volatile memories 240. Then, when the power-off situation is restored through the auxiliary power supply 210, the storage controller 230 may resume the pre-program operation and/or the re-program operation.

The plurality of non-volatile memories 240 and the buffer memory 250 are substantially the same as those described above in FIG. 1, and thus further descriptions thereof are omitted.

As set forth above, according to example embodiments, a storage device capable of reducing the backup amount of data during a sudden power-off (SPO) event and a method for program may be provided.

As used herein, the terms “comprises”, “comprising”, “includes”, “including”, “has”, “having” and any other variations thereof specify the presence of the stated features, steps, operations, elements, components, and/or groups but do not preclude the presence or addition of one or more other features, steps, operations, elements, components, and/or groups thereof. In addition, it will be understood that, although the terms “first”, “second”, “third”, etc. may be used herein to describe various elements, these elements should not be limited by these terms. Rather, these terms are only used to distinguish one element from another. For example, a first element could be termed a second element, and, similarly, a second element could be termed a first element, without departing from the scope of the present disclosure. Further, as used herein, the term “and/or”includes any and all combinations of one or more of the associated listed items.

While example embodiments have been shown and described above, it will be apparent to those skilled in the art that modifications and variations can be made thereto without departing from the scope of the present disclosure as defined by the appended claims.

What is claimed is:

1. A storage device comprising:
a plurality of non-volatile memories; and
a storage controller electrically connected to the plurality of non-volatile memories through a plurality of channels and a plurality of ways, wherein the plurality of ways are included in way groups,
wherein the storage controller is configured to:
pre-program input data into the plurality of non-volatile memories through the plurality of ways; and
re-program the input data into the plurality of non-volatile memories through different ones of the way groups during time periods that do not overlap with each other, after the pre-program is completed.

2. The storage device of claim 1, further comprising a buffer memory configured to buffer the input data,
wherein each of the plurality of non-volatile memories is electrically connected to one of the plurality of channels through a respective one of the plurality of ways.

3. The storage device of claim 1, wherein the storage controller is configured to re-program the input data through a first one of the way groups during one of the time periods.

4. The storage device of claim 3, wherein the storage controller is configured to back up the input data for the first one of the way groups in response to detection of a sudden power-off (SPO) event during the one of the time periods.

5. The storage device of claim 1, wherein the storage controller is configured to set a number of the ways included in each of the way groups.

6. The storage device of claim 1, wherein a number of the way groups is two.

7. The storage device of claim 1, wherein the storage controller is configured to pre-program additional input data into at least one of the plurality of non-volatile memories through one of the way groups, after the re-program of the input data through the one of the way groups is completed.

8. The storage device of claim 7, wherein the storage controller is configured to simultaneously initiate the pre-program of the additional input data through the one of the way groups and the re-program of the input data through another one of the way groups during one of the time periods.

9. The storage device of claim 1, wherein the storage controller is configured to:
dequeue a command from a queue;
perform the pre-program in response to the command indicating a pre-program operation; and
determine a number of ways, among the plurality of ways, in which the re-program is being performed, in response to the command not indicating a pre-program operation.

10. The storage device of claim 9, wherein the storage controller is configured to:
enqueue the command into a pending queue in response to the number of ways being greater than or equal to a predetermined threshold value; and
perform the re-program in response to the number of ways being less than the predetermined threshold value.

11. The storage device of claim 1, wherein a re-program verify voltage configured for the re-program is higher than a pre-program verify voltage configured for the pre-program.

12. A method of operating a storage device, the method comprising:
pre-programming input data into a plurality of non-volatile memories through a plurality of channels and a plurality of ways, wherein the plurality of ways are included in way groups; and
re-programming the input data into the plurality of non-volatile memories through different ones of the way groups during time periods that do not overlap with each other, after the pre-programming is completed.

13. The method of claim 12, wherein the re-programming is performed through a first one of the way groups during one of the time periods to re-program the input data.

14. The method of claim 13, further comprising:
detecting a sudden power-off (SPO) event for the storage device; and
backing up the input data for the first one of the way groups in response to detecting the SPO event during the one of the time periods.

15. The method of claim 12, further comprising setting a number of the ways included in each of the way groups.

16. The method of claim 12, further comprising pre-programming additional input data into at least one of the plurality of non-volatile memories through one of the way groups after the re-programming of the input data through the one of the way groups is completed.

17. The method of claim 12, further comprising:
dequeuing a command from a queue;
performing the pre-programming in response to the command indicating a pre-program operation; and
determining a number of ways, among the plurality of ways, in which the re-programming is being performed, in response to the command not indicating a pre-program operation.

18. The method of claim 17, further comprising:
enqueuing the command into a pending queue in response to the number of ways being greater than or equal to a predetermined threshold value; and
performing the re-programming in response to the number of ways being less than the predetermined threshold value.

19. A storage device comprising:
a plurality of non-volatile memories; and
a storage controller electrically connected to the plurality of non-volatile memories through a plurality of channels and a plurality of ways,
wherein the storage controller is configured to:
pre-program input data into the plurality of non-volatile memories through the plurality of ways; and
re-program the input data into at least one of the plurality of non-volatile memories through ones of the plurality of ways, a number of which is less than a predetermined threshold value, during a time period.

20. The storage device of claim 19, wherein the storage controller is configured to set the predetermined threshold value, and
wherein the predetermined threshold value is less than or equal to a total number of the plurality of ways.
